(19) United States
(12) Patent Application Publication
(10) Pub. No.: US 2026/0217600 A1
(43) Pub. Date: Jul. 30, 2026

(54) MINERAL WOOL BINDER BASED ON PHENOL FORMALDEHYDE RESIN AND PROTEIN

(71) Applicant: ROCKWOOL A/S, Hedehusene (DK)

(72) Inventors: Lars NAERUM, Hedehusene (DK); Thomas HJELMGAARD, Hedehusene (DK); Jens-Uwe WICHMANN, Hedehusene (DK); Josefine Øgaard SVENDSEN, Hedehusene (DK)

(21) Appl. No.: 19/141,372

(22) PCT Filed: Dec. 22, 2023
(86) PCT No.: PCT/EP2023/087696

§ 371 Date: Jun. 20, 2025

(30) Foreign Application Priority Data
Dec. 23, 2022 (EP) 22216566.4

(51) Int. Cl. C03C 25/34; C03B 37/012

(52) U.S. Cl. CPC C03C 25/34; C03B 37/01288

(57) ABSTRACT

The invention is directed to an aqueous binder composition made of a mixture of i) a phenol-urea-formaldehyde binder (PUF binder), and ii) a protein binder comprising at least one protein and iii) at least one cross-linker selected from phenol containing compounds. The aqueous binder composition is suitable for producing a mineral fibre product by contacting mineral fibres with the aqueous binder composition and curing the binder.

### FIELD OF THE INVENTION

The present invention relates to an aqueous binder composition comprising a mixture of a phenol-urea-formaldehyde binder and a protein binder, a method of producing a mineral wool product with the aqueous binder composition, and the mineral wool product prepared by the method.

### BACKGROUND OF THE INVENTION

Mineral wool products generally comprise man-made vitreous fibres (MMVF) such as, e.g., glass fibres, ceramic fibres, basalt fibres, slag wool, mineral wool and stone wool (rock wool), which are bonded together by a cured thermoset polymeric binder material. For use as thermal or acoustical insulation products, bonded mineral fibre mats are generally produced by converting a melt made of suitable raw materials to fibres in conventional manner, for instance by a spinning cup process or by a cascade rotor process. The fibres are blown into a forming or spinning chamber and, while airborne and while still hot, are sprayed with a binder solution and randomly deposited as a mat or web onto a travelling conveyor. The fibre mat is then transferred to a curing oven where heated air is blown through the mat to cure the binder and rigidly bond the mineral fibres together.

Phenolic binders, in particular phenol-formaldehyde resole resins are frequently used in the manufacture of mineral fibre insulation materials, such as insulative batts for walls, roof boards, ceiling tiles, insulative coverings for pipes, and the like.

Typically, when a phenol-formaldehyde resole resin is used as a binder, a significant amount of formaldehyde is released into the environment during processing, in particular cure. Formaldehyde also can be released subsequently from the cured resin. Such formaldehyde emission is undesirable, particularly in enclosed spaces, because it is hazardous to human health and to the environment. Formaldehyde has been classified as carcinogenic to humans by The International Agency for Research on Cancer (IARC) of the World Health Organization (WHO); see the iARC Monograph on Formaldehyde, Volume 88 (2006). It is therefore desirable to reduce the release of formaldehyde into the environment.

Various techniques have been used to reduce formaldehyde emission from formaldehyde-based resins. In particular, various formaldehyde scavengers have been used for that purpose. For instance, urea acts as a formaldehyde scavenger both at, and subsequent to, the manufacture of bonded mineral fibre products. Urea is typically added directly to the phenol-formaldehyde resin to produce a urea-modified phenol-formaldehyde resole resin also called phenol-urea-formaldehyde resole resin. To obtain a typical urea-modified resole binder resin, a mixture of phenol and formaldehyde is reacted with a suitable basic catalyst in one or more steps. The reaction conditions, temperature, amount of catalyst, etc., are adjusted to favour phenol methylolation reactions over condensation reactions. Urea is then added before or after inactivating the resin just prior to use of the resin. Such a resin is typically referred to as a PUF resin, or PUF binder.

Another commonly used formaldehyde scavenger is ammonia which binds formaldehyde with formation of amine compounds such as hexamethylene tetramine.

For instance, WO 96/26164 describes a phenol-formaldehyde resin composition for use as a binder in mineral wool products wherein the emission of phenol is reduced by using a stoichiometric excess of formaldehyde over phenol, wherein the emission of the excess formaldehyde is reduced by adding ammonia as a formaldehyde scavenger and wherein the emission of ammonia is reduced by reacting the ammonia with a sugar compound.

Other thermosetting phenol-formaldehyde resole resin-type mineral wool binder systems that contain a sugar component are known in the art. For instance, WO 2006/136614 discloses a binder system similar to that of WO 96/26164 but substituting hydroxylamine or an amino alcohol for ammonia. U.S. Pat. No. 4,339,361 discloses phenol-formaldehyde resole resins which are suitable for use in binder systems for bonding mineral fibre products and which are extended with an amide or amine such as urea and a sugar as inexpensive extenders. The sugar component may be selected from mono- and oligosaccharides and water-soluble polysaccharides.

A further effect in connection with previously known aqueous binder compositions for mineral fibres is that at least the majority of the starting materials used for the productions of these binders stem from fossil fuels. There is an ongoing trend of consumers to prefer products that are fully or at least partly produced from renewable materials and there is therefore a need to provide binders for mineral wool, which are at least partly produced from renewable materials. In this regard, inter alia binders based on protein or sugar have been developed.

WO 2017/194722 describes a formaldehyde-free binder composition for mineral fibres comprising at least one phenol and/or quinone containing compound, and at least one protein.

WO 2017/194721 relates to a mineral wool product comprising mineral fibres bound by a cured binder wherein the binder in its uncured state comprises at least one protein, and at least one enzyme.

Such binders based on renewable sources such as protein exhibit favourable properties. However, as compared to conventional phenolics binders there are also some drawbacks. Thus, protein based binders can show in its cured state a higher solubility and higher water absorption which are undesirable properties as it impairs it use in certain application fields.

As discussed above, modification of phenol-urea-formaldehyde binder with ammonia as a formaldehyde scavenger is a known method to reduce the formaldehyde emission of the binder during use. On the other hand, the modification with ammonia increases the ammonia emission of these systems. This is a particular problem when such binder is applied to mineral fibres in a spinning chamber. As mentioned above, mineral fibres produced are blown into such a spinning chamber and are still hot. Under these conditions, the volatiles present in the uncured binders will be evaporated during application. As a result, a relatively high ammonia emission is caused when such binders are applied on the mineral fibers in the spinning chamber which is highly undesirable.

Accordingly, there is still a need to provide an aqueous binder composition based on a phenol-formaldehyde type binder suitable for bonding mineral fibers to prepare mineral fiber products, wherein the binder composition generates only a small amount of harmful gases during processing. In particular, the ammonia emission shall be reduced while the formaldehyde emission is also kept low. At the same time mineral fibres products resulting from applying the binder to mineral fibers and curing shall have very good mechanical properties and a satisfactory low water uptake and a low solubility.

### SUMMARY OF THE INVENTION

Accordingly, it was an object of the present invention to provide an aqueous binder composition which overcomes or alleviates the drawbacks of the prior art discussed above. Specifically, it was an object of the present invention to provide a phenol-urea-formaldehyde based binder for mineral fibers having a reduced ammonia emission during processing of the binder while the formaldehyde emission is still kept low, in particular during application of the binder on mineral fibers in a spinning chamber where the temperature of the fibers is still elevated.

At the same time the binder in the cured state should show satisfactory properties with respect to mechanical strength, solubility and water absorption.

The inventors surprisingly found that the object can be solved by providing a binder composition made of a mixture of phenol-urea-formaldehyde type binder (PUF binder) and a particular protein binder though these binder systems are commonly judged to be incompatible with each other.

Accordingly, the present invention relates to an aqueous binder composition made of a mixture of
i) a phenol-urea-formaldehyde binder (PUF binder), and
ii) a protein binder comprising at least one protein and at least one cross-linker selected from phenol containing compounds.

The present inventors have surprisingly found that the mixed binder according to the present invention provides improved properties as compared to both the pure PUF binder and the pure protein binder.

In particular, the addition of the particular protein binder to the PUF binder can not only reduce the ammonia emission but also the formaldehyde emission during processing, in particular during application of the binder on mineral fibers in a spinning chamber.

Thus, in PUF binders modified with ammonia as formaldeyde scavenger, the addition of the protein binder does not only result in a drastic reduction of ammonia emission but also significantly reduces formaldehyde emission. In general, the reduction in ammonia emission is larger than the degree of substitution of the PUF binder. The reduction in formaldehyde emission is even more pronounced.

A PUF binder not including ammonia as a formaldehyde scavenger removes most of the ammonia emission but also results in a very high formaldehyde emission. This formaldehyde emission in an ammonia free PUF binder can then be strongly decreased by partial substitution with the protein binder.

As a result, the inventive mixture of PUF binder and protein binder can reduce both the ammonia and formaldehyde emission as compared to a pure PUF binder which also enables a partial or complete removal of ammonia from the PUF binder. Without wishing to be bound by any theory, it is assumed that these improvements are at least in part caused by a very strong binding/crosslinking of the protein with the formaldehyde.

A further benefit of reducing or omitting the amount of ammonia in PUF binders by adding the protein binder is that the tendency to gel often encountered in these systems decreases. This substitution allows for avoiding the risk of gelling of the binder system.

The inventive mixed binders usually retain and in most cases even significantly improve the mechanical strength when compared to the pure PUF binder. Especially the aged mechanical strength is generally significantly improved.

When starting from the protein binder, the addition of the PUF binder also results in significant improvements as compared to the pure protein binder. As discussed above, drawbacks of protein binders are a relatively high solubility and water uptake in the cured state. However, even small amounts of PUF binder mixed into a protein binder results, after curing, in a nearly insoluble binder with lowered water uptake and bars that are very hard even directly after removal from water bath at 80° C. This indicates that the PUF binder is very efficient as crosslinker for protein binders.

The improvements described for the mixed binders are to such an extent that they generally cannot be explained by additive effects but shows a synergistic interaction between the two binder systems mixed.

### DESCRIPTION OF THE PREFERRED EMBODIMENTS

The present invention is directed to an aqueous binder composition made of a mixture of
i) a phenol-urea-formaldehyde binder (PUF binder), and
ii) a protein binder comprising at least one protein and at least one cross-linker selected from phenol containing compounds.

The aqueous binder composition of the present invention is a mixed binder composition obtainable by mixing two stand-alone binders, namely a phenol-urea-formaldehyde binder and a protein binder. Here, the phenol-urea-formaldehyde binder is also called PUF binder which is a common designation for such binder systems. Stand-alone binders are generally complete binders which can be used as such as a binder.

The aqueous binder composition of the present invention as well as both the PUF binder and the protein binder are particularly suitable as a binder for mineral fibers in order to produce mineral fiber products.

The binder composition of the present invention is an aqueous binder composition, i.e the binder composition contains water. Usually, both the PUF binder and the protein binder are aqueous binders. Water can be added to the mixture, if necessary, for instance, in order to adjust the desired properties such as viscosity.

### PUF Binder

Phenol-urea-formaldehyde binders (PUF binders) which are based on a phenol-urea-formaldehyde resin (PUF resin) are well-known to the skilled person and have a broad range of applications, for instance as a binder for mineral fibers in the production of mineral fiber products.

In accordance with the present invention, the nature of the PUF binder is not critical, and any PUF binder known in the art may be used. A PUF binder which is a mixture of phenol formaldehyde binder (PF binder) and urea formaldehyde binder (UF binder) may be also used.

Starting materials for preparing a PUF binder based on PUF resin are generally phenol, urea, formaldehyde and a base as a catalyst. Optionally further materials can be used in the reaction, such as formaldehyde scavengers such as ammonia, and hardening agents such as ammonia salts such as ammonium sulfate. Formaldehyde can be introduced into the reaction, for instance, as an aqueous solution (formalin) or in form of para-formaldehyde.

The base used in the process of preparing the PUF resin or binder can include at least one basic alkali metal or alkaline earth metal compound or amine catalyst, such as triethyl amine (TEA). Examples of alkali metal bases which can be used include the hydroxides of sodium, potassium and lithium. Examples of alkaline earth metal bases which can be used include the oxides and hydroxides of calcium, barium and strontium, such as calcium oxide and calcium hydroxide.

The PUF binder used for the aqueous binder composition according to the invention is typically a phenol-urea-formaldehyde resole binder. Resole resins or resole-type binders, respectively are obtained by use of a stoichiometric excess of formaldehyde with respect to phenol, i.e. the molar ratio of aldehyde to phenol is greater than 1.

Specific examples of suitable PUF resol resins or binders are, for instance, those disclosed in EP-A-148050, EP-A-810981, CA-A-1001788 and U.S. Pat. No. 5,371,140; the emulsifiable phenolic resins disclosed in EP-A-1084167; the overcondensed phenolic resins disclosed in WO 99/03906 and WO 2009/136106.

The production of PUF binders or PUF resins, respectively, typically involves the reaction of phenol and formaldehyde in aqueous alkaline solutions to prepare phenol formaldehyde resins. Urea can be introduced during or after the resin preparation to achieve the phenol-urea-formaldehyde resin.

In a preferred embodiment, the molar ratio of phenol to formaldehyde used for preparing the PUF binder is from 1:2.5 to 1:6; preferably from 1:3 to 1:5.

In a preferred embodiment, the amount of urea used for preparing the PUF binder is from 20 to 60% by weight, preferably 30 to 50% by weight, based on total weight of phenol, formaldehyde and urea used for preparing the PUF binder.

More specifically, an exothermic condensation reaction of the phenol and the aldehyde is initiated after mixing the phenol and the aldehyde by addition of the base in aqueous solution. For example, an aqueous mixture of phenol and formaldehyde can be maintained at a first temperature of, for instance, 40 to 50° C., as the basic catalyst is added. The temperature can then be permitted to rise to a second reaction temperature of, for instance, 60 to 90° C. In an alternative embodiment, the aqueous mixture of phenol and formaldehyde can be heated in the presence of a base with a continuous heating rate of, e.g., 0.5° C./min to 1.5° C./min, such as about 1° C./min, up to an end temperature of e.g. 60° C. to 90° C., e.g. about 84° C., and maintained at the end temperature for a certain time.

Preferably, the reaction of phenol and formaldehyde is carried out for a sufficient reaction time and at a suitable temperature to provide a resin, preferably a resol resin, having an acid tolerance of <8, preferably within the range of 0.5 to 7, more preferably 3 to 5. Acid tolerance is a measure of the reaction degree. A method for its determination is given in the experimental part below.

The degree of conversion of phenol is preferably >95%, more preferably >97%.

The urea may be added to the resin, in particular the resol resin, during its preparation or in a post-reaction step.

A hardening agent may be added to the reaction mixture such as ammonium sulphate or an acid such as sulfuric acid.

The PUF resin or PUF binder can be a PUF resin or PUF binder which is modified with ammonia or the PUF resin or PUF binder can be a PUF resin or PUF binder which is not modified with ammonia. It is preferred that the PUF binder is not modified with ammonia. As mentioned, ammonia can serve as a formaldehyde scavenger. The modification of the PUF resin or PUF binder with ammonia is carried out by addition of ammonia, for instance as a gas but usually in form of an aqueous solution of ammonia, to the reaction material or PUF resin, preferably after the formation of the phenol-urea-formaldehyde resin or phenol-urea-formaldehyde resole resin. It should be noted that ammonia here only means ammonia as such, i.e. it does not include ammonium salts, which may be added as additives. This applies also to the following indications as to the suitable amounts.

In a preferred embodiment, the amount of ammonia is 0 to 6% by weight, more preferably 0 to 4% by weight, more preferably 0 to 3% by weight, based on the binder component solids of the PUF binder. As mentioned, the PUF binder is more preferably not modified with ammonia, i.e. the amount of ammonia is 0%. In case the PUF binder or PUF resin is modified with ammonia, a suitable lower limit of ammonia may be, for instance, at least 0.1% by weight, based on the binder component solids of the PUF binder. Thus in the case of modification with ammonia, the amount of ammonia may be for instance 0.1 to 6% by weight, preferably 0.5 to 4% by weight, more preferably 1 to 3%, based on the binder component solids of the PUF binder. The binder component solids of the PUF binder is defined below with respect to the description of the mixture.

The aqueous composition obtained containing the PUF resin, preferably PUF resole resin, can be used as the PUF binder for the aqueous binder composition of the present invention. Optionally, water may be added to adjust the viscosity of the PUF binder. Moreover, additives can be optionally added to the PUF binder.

### Protein Binder

The second binder for the mixed aqueous composition of the invention is a protein binder comprising i) at least one protein and iii) at least one cross-linker selected from phenol containing compounds.

The protein binder is usually an aqueous binder. Moreover, the protein binder is usually a formaldehyde-free binder. The binder can contain one or more proteins.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

It is preferred that the protein binder has a pH in the range of 4.5 to 9.5, preferably 5.0 to 8.0 or 6.0 to 8.0.

### Protein

The protein of the protein binder may be selected from proteins from animal sources; proteins from jellyfish, proteins produced by recombinant techniques; proteins from insects; proteins from vegetable sources, including gluten, and mussel foot protein. The protein is preferably selected from proteins from animal sources, such as collagen, gelatin, hydrolysed gelatin, and proteins from vegetable sources, such as gluten, or a combination thereof.

In a preferred embodiment, the protein of the protein binder used in the aqueous binder composition according to the present invention is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; proteins from vegetable sources, including gluten, proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; mussel foot protein, or a combination thereof.

In one embodiment, the protein binder comprises at least two proteins, wherein one protein is at least one selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, such as mussel foot protein; and another protein is at least one protein selected from group of proteins from vegetable sources, including gluten, proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds.

In one embodiment, the protein binder does not comprise a protein from soybeans (soy protein). In one embodiment, the protein contained in the protein binder contains 50 to 400, such as 100 to 300 (hydroxy proline+proline) residues per 1000 amino acid residues.

It is preferred that the at least one protein comprises or is selected from collagen, gelatin, hydrolysed gelatin, gluten or a combination thereof.

In a more preferred embodiment, the at least one protein comprises or is gelatin, gluten or a combination thereof, wherein gelatin is most preferred.

Collagen is a very abundant material in living tissue: It is the main component in connective tissue and constitutes 25-35% of the total protein content in mammals.

Gelatin is derived from chemical degradation of collagen. Gelatin may also be produced by recombinant techniques. Gelatin is water soluble and has typically a molecular weight of 10.000 to 500.000 g/mol, such as 30.000 to 300.000 g/mol dependent on the grade of hydrolysis. Gelatin is a widely used food product and it is therefore generally accepted that this compound is totally non-toxic and therefore no precautions are to be taken when handling gelatin.

Gelatin is a heterogeneous mixture of single or multi-stranded polypeptides, typically showing helix structures. Specifically, the triple helix of type I collagen extracted from skin and bones, as a source for gelatin, is composed of two α1(I) and one α2(I) chains.

Gelatin solutions may undergo coil-helix transitions. A type gelatins are produced by acidic treatment. B type gelatins are produced by basic treatment.

Chemical cross-links may be introduced to gelatin. In one embodiment, transglutaminase is used to link lysine to glutamine residues; in one embodiment, glutaraldehyde is used to link lysine to lysine, in one embodiment, tannins are used to link nucleophilic residues, such as lysine residues.

The gelatin can also be further hydrolysed to smaller fragments of down to 3000 g/mol.

On cooling a gelatin solution, collagen like helices may be formed. Gelatin may form helix structures. In one embodiment, the cured binder comprising protein comprises helix structures.

In one embodiment, the at least one protein is a low strength gelatin, such as a gelatin having a gel strength of 10 to 125 Bloom. In one embodiment, the at least one protein is a medium strength gelatin, such as a gelatin having a gel strength of 125 to 180 Bloom. In one embodiment, the at least one protein is a high strength gelatin, such as a gelatin having a gel strength of 180 to 300 Bloom.

In a preferred embodiment, the gelatin is originating from one or more sources from the group consisting of mammal, bird species, such as from cow, pig, horse, fowl, and/or from scales, skin of fish.

Gluten is a structural protein naturally found in certain grains of cereals such as wheat, such as common wheat, durum, spelt, khorasan, emmer and einkorn; barley; rye; and some oat cultivars. Gluten is a generic term for a family of proteins. The main types of these proteins are prolamins and glutelines. The respective wheat proteins are called glutenins (for the glutelines) and gliadins (for the prolamins) which in turn can be divided into high molecular and low molecular glutenins and α/β, γ and Ω gliadins. Gluten generally makes up 75-85% of the total protein in bread wheat.

Without wanting to be bound by any specific theory, the inventors of the present invention believe that the surprisingly good results achieved are at least partly due to a denaturation process of the at least one protein in the protein binder which may occur during curing. Denaturation is a process in which the proteins lose the quaternary structure, tertiary structure, and/or secondary structure which is present in their native state.

In one embodiment, urea may be added to the binder compositions according to the present invention. The inventors have found that the addition of even small amounts of urea causes denaturation of the gelatin, which can slow down the gelling, which might be desired in some embodiments. The addition of urea might also lead to a softening of the product.

The inventors have found that the carboxylic acid groups in gelatins interact strongly with trivalent and tetravalent ions, for example aluminum salts. This is especially true for type B gelatins which contain more carboxylic acid groups than type A gelatins.

Cross-Linker Selected from Phenol Containing Compounds

The protein binder used as the second binder for the aqueous binder composition according to the present invention further comprises at least one cross-linker selected from phenol containing compounds, in particular one or more phenol containing compounds.

The inventors have found that a wide range of such phenol containing compounds can be used in for the protein binder. Often, these phenol containing compound components are obtained from vegetable tissues and are therefore a renewable material. In some embodiments, the compounds are also non-toxic and non-corrosive. As a further advantage, these compounds are antimicrobial and therefore impart their antimicrobial properties to the mineral wool product bound by such a binder.

Phenol containing compounds, or phenolics, are compounds that have one or more hydroxyl group attached directly to an aromatic ring. Polyphenols (also designated polyhydroxyphenols) are compounds that have more than one phenolic hydroxyl group attached to one or more aromatic rings. Phenol containing or phenolic compounds are characteristic of plants and as a group they are usually found as esters or glycosides rather than as free compounds.

The term phenol containing compound covers a very large and diverse group of chemical compounds. Preferably, the phenol containing compound is a compound according to the scheme based on the number of carbons in the molecule as detailed in by W. Vermerris, R. Nicholson, in Phenolic Compound Biochemistry, Springer Netherlands, 2008.

In one embodiment, the phenol containing compound is selected from the group consisting of simple phenolics, phenol containing compounds with a more complex structure than a C6 structure, such as oligomers of simple phenolics, polyphenols (polyhydroxyphenols). The phenol containing compound is preferably a polyphenol or polyhydroxyphenol, respectively.

Examples for the at least one phenol containing compound are phenol containing compounds selected from the group consisting of simple phenol compounds, such as hydroxybenzoic acids, hydroxybenzoic aldehydes, hydroxyacetophenones, hydroxyphenylacetic acids, cinnamic acids, cinnamic acid esters, cinnamyl aldehydes, and cinnamyl alcohols; coumarins, such as isocoumarins; chromones; flavonoids; chalcones, such as dihydrochalcones; aurones; flavanones, such as flavanonols; flavans; leucoanthocyanidins; flavan-3-ols; flavones; anthocyanidins; deoxyanthocyanidins; anthocyanins; biflavonyls; benzophenones; xanthones; stilbenes; betacyanins; polyphenols and/or polyhydroxyphenols, such as lignans, neolignans (dimers or oligomers from coupling of monolignols such as p-coumaryl alcohol, coniferyl alcohol and sinapyl alcohol), lignins (synthesized primarily from the monolignol precursors p-coumaryl alcohol, coniferyl alcohol and sinapyl alcohol), tannins, such as tannates (salts of tannins), condensed tannins (proanthocyanidins), hydrolysable tannins, gallotannins, ellagitannins, complex tannins, tannic acid, phlobabenes, such as phlorotannins; sulfonated phenolic containing compounds and combinations thereof.

In one embodiment, the phenol containing compound according to the method of the present invention is a quinone. Quinones are oxidized derivatives of aromatic compounds and are often readily made from reactive aromatic compounds with electron-donating substituents such as phenolics. Quinones useful for the present invention include benzoquinones, napthoquinone, anthraquinone and lawsone.

Tannins comprise a group of compounds with a wide diversity in structure that share their ability to bind/crosslink and precipitate proteins. Tannins are abundant in many different plant species, in particular oak, chestnut, staghorn sumac and fringe cups. Tannins can be present in the leaves, bark and fruits. Tannins can be classified into three groups: condensed tannins, hydrolysable tannins and complex tannins. Condensed tannins, or proanthocyanidins, are oligomeric or polymeric flavonoids consisting of flavan-3-ol (catechin) units. Gallotannins are hydrolysable tannins with a polyol core substituted with 10-12 gallic acid residues. The most commonly found polyol in gallotannins is D-glucose although some gallotannins contain catechin and triterpenoid units as the core polyol. Ellagitanins are hydrolysable tannins that differ from gallotannins in that they contain additional C—C bonds between adjacent galloyl moieties. Complex tannins are defined as tannins in which a catechin unit is bound glycosidically to either a gallotannin or an ellagitannin unit.

In a particularly preferred embodiment, the at least one phenol containing compound comprises or is tannin. The tannin is preferably selected from one or more from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

In a particular preferred embodiment of the protein binder, the at least one protein comprises or is gelatin, gluten or a combination thereof and the at least one phenol containing compound comprises or is tannin.

It is preferred that the content of the at least one phenol containing compound in the protein binder is in the range of 1 to 30% by weight, more preferably 2 to 15% by weight, most preferably 3 to 10% by weight, based on dry weight of the least one protein, wherein it is preferred that the at least one phenol containing compound is tannin and/or the least one protein is gelatin.

### Fatty Acid Ester of Glycerol

In a preferred embodiment, the protein binder as the second component of the aqueous binder composition of present invention further comprises at least one fatty acid ester of glycerol.

If a fatty acid ester of glycerol is included in the protein binder, the content of fatty acid ester of glycerol is preferably 0.6 to 30, more preferably 2 to 10, more preferably 3 to 7.5% by weight, based on the dry weight of the at least one protein and the at least one phenol containing compound.

A fatty acid is a carboxylic acid with an aliphatic chain, which is either saturated or unsaturated. Glycerol is a polyol compound having the IUPAC name propane-1,2,3-triol. Naturally occurring fats and oils are glycerol esters with fatty acids (also called triglycerides). For the purpose of the present invention, the term fatty acid ester of glycerol refers to mono-, di-, and tri-esters of glycerol with fatty acids.

While the term fatty acid can in the context of the present invention be any carboxylic acid with an aliphatic chain, it is preferred that it is carboxylic acid with an aliphatic chain having 4 to 28 carbon atoms, preferably of an even number of carbon atoms. Preferably, the aliphatic chain of the fatty acid is unbranched.

In a preferred embodiment, the at least one fatty acid ester of glycerol is in form of a plant oil and/or animal oil. In the context of the present invention, the term “oil” comprises at least one fatty acid ester of glycerol in the form of oils or fats.

In a preferred embodiment, the at least one fatty acid ester of glycerol is in form of fruit pulp fats such as palm oil, olive oil, avocado oil; seed-kernel fats such as lauric acid oils, such as coconut oil, palm kernel oil, babassu oil and other palm seed oils, other sources of lauric acid oils; palmitic-stearic acid oils such as cocoa butter, shea butter, borneo tallow and related fats (vegetable butters); palmitic acid oils such as cottonseed oil, kapok and related oils, pumpkin seed oil, corn (maize) oil, cereal oils; oleic-linoleic acid oils such as sunflower oil, sesame oil, linseed oil, perilla oil, hempseed oil, teaseed oil, safflower and niger seed oils, grape-seed oil, poppyseed oil, leguminous oil such as soybean oil, peanut oil, lupine oil; cruciferous oils such as rapeseed oil, mustard seed oil; conjugated acid oils such as tung oil and related oils, oiticica oil and related oils; substituted fatty acid oils such as castor oil, chaulmoogra, hydnocarpus and gorli oils, vernonia oil; animal fats such as land-animal fats such as lard, beef tallow, mutton tallow, horse fat, goose fat, chicken fat; marine oils such as whale oil and fish oil.

In a preferred embodiment, the at least one fatty acid ester of glycerol is in form of a plant oil, in particular selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, sunflower oil, wherein linseed oil is particularly suitable.

In one embodiment, the at least one fatty acid ester of glycerol is not of natural origin. In one embodiment, the at least one fatty acid ester of glycerol is a modified plant or animal oil. In one embodiment, the at least one fatty acid ester of glycerol comprises at least one trans-fatty acid. In an alternative preferred embodiment, the at least one fatty acid ester of glycerol is in form of an animal oil, such as a fish oil.

In a preferred embodiment, the protein binder comprises at least one protein which is or comprises gelatin and at least one cross-linker selected from phenol containing compounds which comprises or is tannin, and at least one fatty acid ester of glycerol, such as at least one fatty acid ester of glycerol selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, sunflower oil.

The present inventors have found that the parameter for the fatty acid ester of glycerol used in the protein binder of the amount of unsaturation in the fatty acid can be used to distinguish preferred embodiments. The amount of unsaturation in fatty acids is usually measured by the iodine number (also called iodine value or iodine absorption value or iodine index). The higher the iodine number, the more C═C bonds are present in the fatty acid. For the determination of the iodine number as a measure of the unsaturation of fatty acids, we make reference to Thomas, Alfred (2012) “Fats and fatty oils” in Ullmann's Encyclopedia of industrial chemistry, Weinheim, Wiley-VCH.

In a preferred embodiment, the at least one fatty acid ester of glycerol comprises a plant oil and/or animal oil having an iodine number of ≥75, such as 75 to 180, such as ≥130, such as 130 to 180. In an alternative preferred embodiment, the at least one fatty acid ester of glycerol comprises a plant oil and/or animal oil having an iodine number of ≤100, such as ≤25.

In a preferred embodiment, the at least one fatty acid ester of glycerol is selected from one or more components from the group consisting of a plant oil having an iodine number in the range of approximately 136 to 178, such as a linseed oil having an iodine number in the range of approximately 136 to 178, a plant oil having an iodine number in the range of approximately 80 to 88, such as an olive oil having an iodine number in the range of approximately 80 to 88, a plant oil having an iodine number in the range of approximately 163 to 173, such as tung oil having an iodine number in the range of approximately 163 to 173, a plant oil having an iodine number in the range of approximately 7 to 10, such as coconut oil having an iodine number in the range of approximately 7 to 10, a plant oil having an iodine number in the range of approximately 140 to 170, such as hemp oil having an iodine number in the range of approximately 140 to 170, a plant oil having an iodine number in the range of approximately 94 to 120, such as a rapeseed oil having an iodine number in the range of approximately 94 to 120, a plant oil having an iodine number in the range of approximately 118 to 144, such as a sunflower oil having an iodine number in the range of approximately 118 to 144.

In one embodiment, the at least one fatty acid ester of glycerol is a drying oil. For a definition of a drying oil, see Poth, Ulrich (2012) “Drying oils and related products” in Ullmann's Encyclopedia of industrial chemistry, Weinheim, Wiley-VCH.

In one embodiment, the at least one fatty acid ester of glycerol is selected from one or more components from the group consisting of linseed oil, olive oil, tung oil, coconut oil, hemp oil, rapeseed oil, and sunflower oil.

Accordingly, the present inventors have found that particularly good results are achieved when the iodine number is either in a fairly high range or, alternatively, in a fairly low range. While not wanting to be bound by any particular theory, the present inventors assume that the advantageous properties inflicted by the fatty acid esters of high iodine number on the one hand and low iodine number on the other hand are based on different mechanisms. The present inventors assume that the advantageous properties of glycerol esters of fatty acids having a high iodine number might be due to the participation of the C═C double-bonds found in high numbers in these fatty acids in a crosslinking reaction, while the glycerol esters of fatty acids having a low iodine number and lacking high amounts of C═C double-bonds might allow a stabilization of the cured binder by van der Waals interactions. The present inventors assume that the polar end of glycerol esters of fatty acids interacts with polar areas of the at least one protein while non-polar ends interact with non-polar areas of the at least one protein.

### Divalent Metal Cation M²⁺ Containing Compound

In one embodiment, the protein binder as the second component of the aqueous binder composition of present invention may further comprise at least one divalent metal cation M²⁺ containing compound.

Without wanting to be bound to any particular theory, the present inventors believe that the reaction between the phenol containing compound and the protein at least partly relies on an oxidation of phenols to quinones followed by nucleophilic attack of nucleophilic groups, such as amine and/or thiol groups from the protein which leads to a crosslinking and/or modification of the proteins by the phenol containing compounds. The improvement by the presence of the divalent metal cation M²⁺ containing compound can be explained by a chelation-effect, in which the M²⁺ crosslinks negatively charge groups of the crosslinked protein.

The at least one divalent metal cation M²⁺ containing compound comprises one or more divalent metal cations M²⁺ selected from the group of divalent cations of earth alkaline metals such as Ca²⁺, Mn, Fe, Cu, Zn, Sn.

In one embodiment, the at least one divalent metal cation compound is contained in the protein binder in an amount of 0.1 wt. % to 10 wt. %, such as 0.2 wt. % to 8 wt. %, such as 0.3 wt. % to 5 wt. %, such as 0.4 wt. % to 4.3 wt. %, such as 1.0 wt. % to 4.3 wt. %, based on the combined dry weight of the at least one phenol containing compound and the at least one protein.

### Further Additives

The protein binder may optionally comprise one or more further additives. Examples of such additives are an oxidiser, such as tyrosinase, a pH-adjuster, preferably in form of a base, such as an organic base, such as an amine or salts thereof, inorganic bases, such as lithium hydroxide, sodium hydroxide and/or potassium hydroxide. The amount of further additives in the protein binder, if used, may be in the range of 0.01 to 15 wt. % or 0.01 to 10 wt. %, preferably 0.05 to 6 wt. %, based on the combined dry weight of the at least one phenol containing compound and the at least one protein.

### Mixing of PUF Binder and Protein Binder

The aqueous binder composition of the present invention can be obtained e.g. by adding the protein binder to the PUF binder or vice versa and, if necessary, mixing the mixture obtained with a mixing device. Common mixing devices such as mixing tanks or static mixers can be used.

In order to obtain the aqueous binder composition of the invention, it is preferred, that the PUF binder and the protein binder are mixed in a ratio such that the proportion by weight B, based on the combined weight of A+B, is in the range of 5 to 95% by weight, more preferably 10 to 90% by weight, wherein B is the weight of the binder component solids of the protein binder and A is the weight of the binder solids of the PUF binder.

The proportion by weight B, based on the combined weight of A+B, may be, e.g., suitably in the range of 15 to 90% by weight, preferably 20 to 90% by weight.

The present invention can also be used to improve the characteristics of the PUF binder or the protein binder depending on the whether the PUF binder or the protein binder is the main component of the aqueous binder composition of the invention.

Thus, in case the PUF binder is the main component of the aqueous binder composition of the invention, the proportion by weight B, based on the combined weight of A+B, is preferably in the range of 5 to 50% by weight, more preferably 10 to 45% by weight, still more preferably 15 to 40% by weight or 20 to 40% by weight or 25 to 40% by weight.

As can be seen in the experimental part below, even low proportions of the protein binder mixed into the PUF binder result in a significant reduction of both ammonia emmission and formaldehyde emission in a PUF binder modified with ammonia and in a significant reduction of formaldehyde emission in a PUF binder not modified with ammonia as compared to the pure binder.

In case the protein binder is the main component of the aqueous binder composition of the invention, the proportion wherein the proportion by weight B, based on the combined weight of A+B, is preferably in the range of 50 to 95% by weight, more preferably 60 to 90% by weight, more preferably 70 to 90% by weight. In other words, the proportion by weight A, based on the combined weight of A+B, is preferably in the range of 5 to 50% by weight, more preferably 10 to 40% by weight, more preferably 10 to 30% by weight.

As can be seen in the experimental part below, even low proportions of the PUF binder mixed into the protein binder result in a significant reduction of binder solubility and water absorption in a resulting binder as compared to the pure protein binder.

Moreover, the inventive aqueous binder composition as compared to both the pure PUF binder and the pure protein binder results in very good mechanical strengths of mineral fiber products produced with the inventive binder. Thus, the show a slight decrease in unaged mechanical strengths are similar and in most cases even significantly improved when compared to the PUF reference, whereas the aged mechanical strengths are generally significantly improved.

In one embodiment, the total amount of PUF binder, the at least one protein and the at least one cross-linker selected from phenol containing compounds in the aqueous binder composition is in the range of 75 to 100% by weight, preferably 85 to 97% by weight, based on the total weight of the binder solids of the PUF binder and the binder component solids of the protein binder.

In the context of the present application, the “binder component solids” and the “binder solids” are defined as follows.

### Binder Component Solids Content-Definition

The content by weight of each of the components in a given binder solution before curing is based on the anhydrous mass of the components, i.e. without solvents, in particular water. The following formula can be used:

$$Binder component solids content ( \% ) = \frac{binder component A solids ( g ) + binder component B solids ( g ) + …}{total weight of mixture ( g )} \times 100 \%$$

In case of a PUF binder, formaldehyde and, if used, ammonia are also considered as components of the binder. While these starting materials are volatiles, they are reacted at least in part during the preparation of the PUF resin.

### Binder Solids—Definition and Procedure

The content by weight of binder after curing is termed “binder solids”.

Disc-shaped stone wool samples (diameter: 5 cm; height 1 cm) were cut out of stone wool and heat-treated at 590° C. for at least 30 minutes to remove all organics. The solids of a binder were measured by distributing a sample of the binder (approx. 2 g) onto a heat treated stone wool disc in a tin foil container. The tin foil container containing the stone wool disc was weighed before and directly after addition of the binder. Two such binder loaded stone wool discs in tin foil containers were produced and they were then heated for 1 h at 200° C. After cooling and storing at room temperature for 10 minutes, the samples were weighed and the binder solids were calculated as an average of the two results.

### A Method of Producing a Mineral Fibre Product

The present invention is also directed to a method of producing a mineral fibre product which comprises the steps of contacting mineral fibres with an aqueous binder composition according to the invention, and curing the binder.

The aqueous binder composition according to the invention has been described above. All indications discussed above for the aqueous binder composition of course also apply to the aqueous binder composition used in the method of the present invention.

The mineral fibres may be for instance any of man-made vitreous fibres (MMVF), glass fibres or glass wool, ceramic fibres, basalt fibres, slag fibres, stone fibres or stone wool and others. These fibres may be present as a wool product, e.g. like a stone wool product or a glass wool product.

The step of contacting the mineral fibers with the aqueous binder composition can be effected by applying the aqueous binder composition on the mineral fibers with conventional means, for instance by spraying.

The curing of the aqueous binder composition which is in contact with the mineral fibers can be carried out within a wide temperature range such as from room temperature to 250° C., e.g. in the range of 15 to 250° C., preferably 150 to 250° C., more preferably 175 to 225° C.

The curing process may commence immediately after application of the binder to the fibres. In one embodiment, the curing takes place in a curing device such as in a conventional curing oven or a heat press.

In one embodiment the curing process comprises a drying process. In one embodiment the curing process comprises drying by pressure. The pressure may be applied by blowing air or gas to the mixture of mineral fibres and binder. The blowing process may be accompanied by heating or cooling or it may be at ambient temperature.

Mineral fibers are generally generated in a fiber forming apparatus where a mineral melt is thrown off from a device such as a cup spinning apparatus or a cascade spinning apparatus, thus forming the mineral fibers. The mineral fibers formed are preferably directed into a spinning chamber.

In a preferred embodiment, the aqueous binder composition is applied in the close vicinity of the fibre forming apparatus, such as a cup spinning apparatus or a cascade spinning apparatus, in either case immediately after the fibre formation. Thus, the aqueous binder composition is preferably applied to the mineral fibers formed in the spinning chamber, preferably by spraying. The fibres with applied binder are thereafter usually conveyed onto a conveyor belt as a web, such as a collected web. The web, such as a collected web may be subjected to longitudinal or length compression after the fibre formation and before substantial curing has taken place.

In a preferred embodiment, the method of producing a mineral fibre product according to the invention comprises the steps of:
making a melt of raw materials,
fiberizing the melt by means of a fibre forming apparatus to form mineral fibres, wherein the mineral fibers formed are preferably directed into a spinning chamber,
providing the mineral fibres in the form of a collected web,
applying the aqueous binder composition on the mineral fibres before, during or after the provision of the collected web to form a mixture of mineral fibres and binder composition, wherein the aqueous binder composition is preferably applied by spraying before the provision of the collected web, preferably in the spinning chamber,
curing the binder composition mixed with the mineral fibres.

There are various types of centrifugal spinners used as a fiber forming apparatus for fiberizing mineral melts.

A conventional centrifugal spinner is a cascade spinner which comprises a sequence of a top (or first) rotor and a subsequent (or second) rotor and optionally other subsequent rotors (such as third and fourth rotors). Each rotor rotates about a different substantially horizontal axis with a rotational direction opposite to the rotational direction of the or each adjacent rotor in the sequence. The different horizontal axes are arranged such that melt which is poured on to the top rotor is thrown in sequence on to the peripheral surface of the or each subsequent rotor, and fibres are thrown off the or each subsequent rotor, and optionally also off the top rotor.

In one embodiment, a cascade spinner or other spinner is arranged to fiberize the melt and the fibres are entrained in air as a cloud of the fibres.

Many fiber forming apparatuses comprise a disc or cup that spins around a substantially vertical axis. It is then conventional to arrange several of these spinners in-line, i.e. substantially in the first direction, for instance as described in GB-A-926,749, U.S. Pat. No. 3,824,086 and WO-A-83/03092.

There is usually a stream of air associated with the one or each fiberizing rotor whereby the fibres are entrained in this air as they are formed off the surface of the rotor.

In one embodiment, the aqueous binder composition of the invention and/or additives are added to the cloud of fibres by known means. The amount of binder and/or additive may be the same for each spinner or it may be different.

As used herein, the term “collected web” is intended to include any mineral fibres that have been collected together on a surface, i.e. they are no longer entrained in air, e.g. the fiberized mineral fibres, granulate, tufts or recycled web waste.

The collected web could be a primary web that has been formed by collection of fibres on a conveyor belt and provided as a starting material without having been cross-lapped or otherwise consolidated.

Alternatively, the collected web could be a secondary web that has been formed by crosslapping or otherwise consolidating a primary web. Preferably, the collected web is a primary web.

### Mineral Fiber Product

The present invention is also directed to a mineral fibre product comprising mineral fibres bound by a binder resulting from the curing of an aqueous binder composition of the invention. The mineral fiber product of the invention is preferably obtainable by the method according to the invention.

The aqueous binder composition and the method according to the invention have been described above. All indications discussed above for the aqueous binder composition and the method such as the mineral fibers also apply to the mineral fiber product of the present invention.

In a preferred embodiment, the density of the mineral fiber product is in the range of 10-1200 kg/m³, such as 30-800 kg/m³, such as 40-600 kg/m³, such as 50-250 kg/m³, such as 60-200 kg/m³.

In a preferred embodiment, the mineral fiber product according to the present invention is an insulation product, such as a thermal or acoustical insulation product, in particular having a density of 10 to 200 kg/m³.

In an alternative embodiment, the mineral fiber product according to the present invention is a facade panel, in particular having a density of 1000-1200 kg/m³.

In a preferred embodiment, the loss on ignition (LOI) of the mineral fiber product according to the present invention is within the range of 0.1 to 25.0%, such as 0.3 to 18.0%, such as 0.5 to 12.0%, such as 0.7 to 8.0% by weight.

The mineral fiber product can be in any conventional configuration, for instance a mat or slab, and can be cut and/or shaped (e.g. into pipe sections) before, during or after curing of the binder.

### Applications

The present invention is also directed to the use of an aqueous binder composition according to the invention for the production of a mineral fibre product.

The present invention is also directed to the use of a protein binder comprising at least one protein and at least one cross-linker selected from phenol containing compounds, in a phenol-urea-formaldehyde binder (PUF binder), to reduce at least one of formaldehyde emission and ammonia emission during application of the resulting aqueous binder composition on mineral fibers in a spinning chamber as compared to the application of the PUF binder without added protein binder on mineral fibers in the spinning chamber. The use according to the invention is preferably carried out in a method according to the invention as described above.

The present invention is also directed to the use of a phenol-urea-formaldehyde binder (PUF binder) in protein binder comprising a combination of at least one protein and at least one cross-linker selected from phenol containing compounds, to reduce the water uptake of a mineral fibre product prepared from the resulting aqueous binder composition and mineral fibers as compared to the water uptake of a mineral fibre product prepared from the protein binder without added PUF binder. The use according to the invention is preferably carried out in a method according to the invention as described above.

The present invention is also directed to a method of reducing the formaldehyde emission and/or the ammonia emission during applying a phenol-urea-formaldehyde binder (PUF binder) on mineral fibers in a spinning chamber, said method comprising the step of adding a protein binder comprising at least one protein and at least one cross-linker selected from phenol containing compounds to the PUF binder and applying the resulting aqueous binder composition instead of the PUF binder on the mineral fibers in the spinning chamber. The method of reducing the formaldehyde emission and/or the ammonia emission according to the invention is preferably a method of producing a mineral fibre product according to the invention.

The present invention is also directed to a method of reducing the water uptake of a mineral fibre product bonded with a cured protein binder comprising a combination of at least one protein and at least one cross-linker selected from phenol containing compounds, said method comprising the step of adding a phenol-urea-formaldehyde binder (PUF binder) to the protein binder and applying the resulting aqueous binder composition instead of the protein binder on mineral fibers and curing the applied binder to obtain a mineral fiber product. The method of reducing the water uptake according to the invention is preferably a method of producing a mineral fibre product according to the invention.

The aqueous binder composition, the method and the mineral fiber product according to the invention have been described above. All indications discussed above for the aqueous binder composition, the method and the mineral fiber product also apply to the uses and methods of the present invention discussed above.

### EXAMPLES

In the following examples, several binders which fall under the definition of the present invention were prepared and compared to binders according to the prior art.

### Experimental Methods and Definitions

### General Experimental Methods

Technical grade gelatine (from hide, skin and animal bones, 150-180 bloom at 12.5%, 30 bloom at 6.67%) was obtained from Cam Moreu S. A. Gluten protein was obtained from Crespel & Deiters GmbH & Co. KG. Mimosa tannin (Seta Sun, mimosa extract) was obtained from Otto Dille. Leinöl Firnis linseed oil was obtained from OLI-NATURA. 40% silane (Momentive Silquest® VS-142, aminoalkylsilane hydrolyzate in water) was supplied by Momentive. 28% aq. ammonia and all other components were obtained in high purity from Sigma-Aldrich or TCI. All components for which a concentration is not detailed above were assumed completely pure and anhydrous for simplicity.

Measurements of pH were performed using a Mettler Toledo SevenCompact™ S220 pH meter equipped with a Mettler Toledo InLab® Expert Pro-ISM pH electrode and temperature probe.

Crude stone shots (predominantly rounded particles which have the same melt composition as the stone wool fibers) formed during the cascade spinning process of a stone melt in the production of stone wool fibers were obtained from a ROCKWOOL factory in the Netherlands. Cleaned and sifted stone shots appropriate for the manufacture of composite bars were produced from these crude stone shots by ProChem GmbH, Germany. In brief, the stone shots were heat treated overnight at 590° C. to remove any trace organics. After cooling, the stone shots were sifted through 0.50 mm and 0.25 mm sieves. The coarse and fine fractions were discarded, and the remaining stone shots were washed thoroughly several times in demineralized water. The sifted and cleaned stone shots were dried and where then stored in a closed bag until use. In the following stone shots obtained are simply termed shots.

FUNKTION heat resistant silicone forms for manufacture of bars (4×5 slots per form; slot top dimension: length=5.6 cm, width=2.5 cm; slot bottom dimension: length=5.3 cm, width=2.2 cm; slot height=1.1 cm) were obtained from F&H of Scandinavia A/S.

Three-point bending tests were recorded on a Bent Tram SUT 3000/520 test machine (test speed: 10.0 mm/min; rupture level: 50 N; nominal strength: 30 N/mm2; support distance: 40 mm; max deflection 20 mm; nominal E-modulus 10000 N/mm2). The bars were placed with the “top face” up (i.e. the face with the dimensions length=5.6 cm, width=2.5 cm) in the machine.

New tin foil containers for use in measurement of binder solids (comparative binders A only) and of loss of ignition of composite bars were heat-treated at 590° C. for 15 minutes prior to use to remove all organics.

An open-end, heated tube oven apparatus was used for the generation of simulated spinning chamber emissions. The emissions generated from binder samples placed within the tube oven at a given temperature were measured by drawing a constant flow of air across the sample through heated tubes to a MKS 2030 FTIR gas analyzer. Series 2000 Multigas Analyzer software (version 10.4) was used to analyze the spectral data.

### Binder Component Solids Content—Definition

The content by weight of each of the components in a given binder solution before curing is based on the anhydrous mass of the components, i.e. without solvents, in particular water. The following formula can be used:

$$Binder component solids content ( \% ) = \frac{binder component A solids ( g ) + binder component B solids ( g ) + …}{total weight of mixture ( g )} \times 100 \%$$

In case of a PUF binder, formaldehyde and, if used, ammonia are also considered as components of the binder. While these starting materials are volatiles, they are reacted at least in part during the preparation of the PUF resin.

### Binder Solids—Definition and Procedure (Comparative Binders A)

The content of binder after curing is termed “binder solids”.

Disc-shaped stone wool samples (diameter: 5 cm; height 1 cm) were cut out of stone wool and heat-treated at 590° C. for at least 30 minutes to remove all organics. The solids of the binder mixture (see below for mixing examples) were measured by distributing a sample of the binder mixture (approx. 2 g) onto a heat treated stone wool disc in a tin foil container. The tin foil container containing the stone wool disc was weighed before and directly after addition of the binder mixture. Two such binder mixture loaded stone wool discs in tin foil containers were produced and they were then heated for 1 h at 200° C. After cooling and storing at room temperature for 10 minutes, the samples were weighed and the binder solids were calculated as an average of the two results.

### Manufacture of Composite Bars (Comparative Binders A)

A 17.5% binder solids solution was obtained as described in the examples below. A sample of the binder solution (70.1 g) was added to shots (460.0 g) in a mixing bowl at room temperature. The resulting mixture was then mixed for approx. 2-5 minutes using a mixing machine. The resulting mixture was then filled into 16 slots in a heat resistant silicone form for making bars. During the manufacture of each composite bar, the mixtures placed in the slots were pressed as required and then evened out with a plastic spatula to generate an even bar surface. Bars made using comparative binders A were cured for 1 h at 200° C. After cooling to room temperature, the composite bars were stored in a climate chamber at 22° C./50% rh.

### Manufacture of Composite Bars (Comparative Binders B)

A 25% binder component solids mixture was obtained as described in the examples below. A sample of the binder mixture (49.1 g) was added to shots (460.0 g) preheated to 50° C. in a mixing bowl, likewise heated to 50° C. The resulting mixture was then mixed for approx. 2-5 minutes using a mixing machine while still heating the mixing bowl to 50° C. The resulting mixture was then filled into 16 slots in a heat resistant silicone form for making bars. During the manufacture of each composite bar, the mixtures placed in the slots were pressed as required and then evened out with a plastic spatula to generate an even bar surface. Bars made using comparative binders B were cured for 1 h at 175° C. After cooling to room temperature, the composite bars were stored in a climate chamber at 22° C./50% rh.

### Manufacture of Composite Bars (Binder Compositions According to the Present Invention)

A 20% binder mixture (for binder mixtures with comparative binder A:comparative binder B proportions of 90:10, 75:25 or 50:50) or a 25% binder mixture (for binder mixtures with comparative binder A:comparative binder B proportions of 25:75 or 10:90) was obtained as described in the examples below. A sample of the binder mixture (61.3 g for 20% binder mixtures; 49.1 g for 25% binder mixtures) was added to shots (460.0 g) preheated to 50° C. in a mixing bowl, likewise heated to 50° C. The resulting mixture was then mixed for approx. 2-5 minutes using a mixing machine while still heating the mixing bowl to 50° C. The resulting mixture was then filled into 16 slots in a heat resistant silicone form for making bars. During the manufacture of each composite bar, the mixtures placed in the slots were pressed as required and then evened out with a plastic spatula to generate an even bar surface. Bars made made using binder mixtures with comparative binder A:comparative binder B proportions 90:10 or 75:25 were cured for 1 h at 200° C. while binder mixtures made using with comparative binder A:comparative binder B proportions 25:75 or 10:90 were cured for 1 h at 175° C. Bars made made using binder mixtures with comparative binder A:comparative binder B proportions 50:50 were cured for 1 h at 175° C. or for 1 h at 200° C. After cooling to room temperature, the composite bars were stored in a climate chamber at 22° C./50% rh.

### Ageing Treatment of Composite Bars

Ageing treatment of composite bars was performed by subjecting the bars to autoclave treatment (15 min/120° C./1.2 bar) or water bath treatment (3 h/80° C.) followed by cooling to room temperature. After initial drying at ambient conditions for one day, the composite bars were stored in a climate chamber at 22° C./50% rh.

### Measurement of Mechanical Strengths of Composite Bars

The maximum load force required to break composite bars was recorded in a three-point bending test. For each data point, an average value was calculated on the basis of four bars that had been subjected to identical treatment. The composite bars were stored in a climate chamber at 22° C./50% rh for at least three days prior to measuring the maximum load force.

### Measurement of Loss of Ignition (LOI) of Composite Bars

The loss of ignition (LOI) of the composite bars was measured in small tin foil containers by treatment at 590° C. The tin foil container was weighed and four bars (usually after being broken in the three-point bending test) were placed into the tin foil container. The ensemble was weighed and was then heat-treated at 590° C. for 30 minutes. After cooling to room temperature, the weight was recorded again and the loss of ignition (LOI) was calculated using the following formula:

$$LOI ( \% ) = \frac{\begin{matrix}Weight of bars before heat treatment ( g ) - \\ Weight of bars after heat treatment ( g )\end{matrix}}{Weight of bars before heat treatment ( g )} \times 100 \%$$

### Binder Solubility—Definition

The binder solubility is defined as the difference in the loss of ignition (LOI) of composite bars after ageing in water bath compared to the LOI of the composite bars before ageing.

### Water Absorption Measurements

The water absorption of the binders was measured by weighing three bars and then submerging the bars in water (approx. 250 mL) in a beaker (565 mL, bottom Ø=9.5 cm; top Ø=10.5 cm; height=7.5 cm) for 24 h. The bars were placed next to each other on the bottom of the beaker with the “top face” down (i.e. the face with the dimensions length=5.6 cm, width=2.5 cm). After the designated amount of time, the bars were lifted up one by one and allowed to drip off for one minute. The bars were held (gently) with the length side almost vertical so that the droplets would drip from a corner of the bar. The bars were then weighed and the water absorption was calculated using the following formula:

$$Water abs . ( \% ) = \frac{\begin{matrix}Weight of bars after water treatment ( g ) - \\ Weight of bars before water treatment ( g )\end{matrix}}{Weight of bars before water treatment ( g )} \times 100 \%$$

### Measurements of Simulated Spinning Chamber Emissions of Ammonia and Formaldehyde

A 20% binder mixture was obtained in an analogous manner to the procedures described in the examples below. Immediately prior to commencing each emission measurement, 700 μL of the binder mixture was distributed evenly on binder-free stone wool samples in a small ceramic crucible. Background ammonia and formaldehyde emissions were obtained by starting the emission measurements in the oven heated to 95° C. a few minutes before inserting the sample. The sample was then loaded into the tube oven and a temperature probe was inserted close to the sample to measure the actual temperature. Gas phase emissions IR spectra were then recorded with a 5 second sample frequency during a period of about 1 hour at 95° C. The recorded individual ammonia and formaldehyde concentration time series obtained from the start of the measurement to the disappearance of the signal from water evaporation (generally about 30 minutes) were integrated to yield the simulated spinning chamber emissions of ammonia and formaldehyde. Three measurements were performed for each binder composition and the emission results were averaged. The results are given in Table 1-1, 1-2 and 1-3 as relative emission indexes compared to comparative binder A1 (index 100).

Comparative Binder Compositions from the Prior Art
Comparative Binders a (Phenol-Formaldehyde Resin Modified with Urea, a PUF-Resol), Comprising Examples A1 and A2

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction. To measure the AT, a titrant is produced from diluting 2.5 mL conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

$$AT = ( Used titration volume ( mL ) ) / ( Sample volume ( mL ) )$$

Using the urea-modified phenol-formaldehyde resin obtained, a binder is made by addition of 28% aq. ammonia (79.3 g for comparative binder A1, and 0 g for comparative binder A2) and ammonium sulfate (12.7 g) followed by water (729 g). The binder solids were then measured as described above and the mixture was diluted with the required amount of water and 4% Momentive VS-142 silane (17.5-25% final binder solids solution, 0.2% silane of binder solids).

### Comparative Binders B (Protein-Based Binder), Example B1

To 0.5 M NaOH (38.5 g) stirred at room temperature was added mimosa tannin (11.0 g). After stirring at room temperature for 5-10 min further, the resulting deep-brown mixture (pH 9.0) was used in the subsequent experiments.

A mixture of technical grade gelatine (28.0 g) in water (116.5 g for 20% binder component solids; 85.4 g for 25% binder component solids) was stirred at 50° C. for approx. 15-30 min until all gelatine had dissolved (pH 5.7). Leinöl Firnis linseed oil (1.47 g) followed by a portion of the above mimosa extract mixture (6.30 g; thus efficiently 1.40 g tannin) and 4% silane (1.47 g, thus efficiently 0.06 g silane) were added (pH 6.8). 1M NaOH (1.75 g) was then added (pH 7.3). After stirring for 1-2 minutes further at 50° C., the resulting brown mixture was used in the subsequent experiments.

### Comparative Binders B (Protein-Based Binder), Example B2

To water (38.5 g) stirred 50° C. was added mimosa tannin (11.0 g). After stirring at 50° C. for 5-10 min further, the resulting deep-brown mixture (pH 4.2) was used in the subsequent experiments.

A mixture of gluten protein (28.0 g) in water (117.4 g for 20% binder component solids) was stirred at room temperature for a few seconds whereupon a portion of the above mimosa extract mixture (6.30 g; thus efficiently 1.40 g tannin) was added. Leinöl Firnis linseed oil (1.47 g) followed by 4% silane (1.47 g, thus efficiently 0.06 g silane) were then added (pH 5.9). After stirring for 5-10 minutes further at room temperature, the resulting light brown mixture was used in the subsequent experiments.

### Binder Compositions According to the Present Invention

### General Binder Example (Binder Mixtures with Comparative Binder A:Comparative Binder B Proportions of 90:10, 75:25 or 50:50), Examples 1-3, 6 and 7-9

To comparative binder A (20% binder solids) stirred at room temperature was added comparative binder B (20% binder component solids). The comparative binders were mixed in in the desired proportions (A:B 90:10, 75:25 or 50:50) on a scale resulting in 60-120 g final binder mixture. After stirring for 1-2 minutes further, the resulting light to dark brown mixtures (pH 8.0-9.6) were used in the subsequent experiments.

### General Binder Example (Binder Mixtures with Comparative Binder A:Comparative Binder B Proportions of 25:75 or 10:90), Examples 4-5 and 10

To comparative binder A (25% binder solids) stirred at room temperature was added comparative binder B (25% binder component solids). The comparative binders were mixed in in the desired proportions (25:75 or 10:90) on a scale resulting in 60-120 g final binder mixture. After stirring for 1-2 minutes further, the resulting light to dark brown mixtures (pH 7.8-9.0) were used in the subsequent experiments.

The compositions of the comparative binders and the inventive binders as well as the results achieved by the test procedures are shown in the following Tables 1-1 to 1-3.

The results achieved for the inventive binders show very good properties in general. For instance, the mechanical strengths are very impressive, especially the aged ones (e.g. Example 1). The ammonia emmission is decreased to a higher extent as expected by the dilution factor with a protein binder and formaldehyde is removed even more efficiently (e.g. Example 1). Even a small amount of PUF binder markedly improves the solubility of the protein binder (e.g. Example 5). Not much protein binder is needed to remove a large part of the formaldehyde emission created by removal of ammonia from a PUF binder (e.g. Example 7).

TABLE 1-1
Binder compositions according to the prior art

| Example | A1 | A2 | B1 | B2 |
|---|---|---|---|---|
| Binder composition | | | | |
| Components ^{[a]} | | | | |
| Formaldehyde | 32.0 | 33.0 | — | — |
| Phenol | 27.0 | 27.8 | — | — |
| Potassium hydroxide | 1.7 | 1.7 | — | — |
| Urea | 34.4 | 35.5 | — | — |
| Ammonia | 3.2 | — | — | — |
| Ammonium sulfate | 1.8 | 1.9 | — | — |
| Glucose syrup | — | — | — | — |
| Ammonium sulfamate | — | — | — | — |
| Hypophosphorous acid | — | — | — | — |
| Technical grade gelatin | — | — | 90.2 | — |
| Gluten protein | — | — | — | 90.7 |
| Mimosa tannin | — | — | 4.5 | 4.5 |
| Linseed oil | — | — | 4.7 | 4.8 |
| Sodium hydroxide | — | — | 0.5 | — |
| Other additives ^{[b]} | | | | |
| Silane | 0.2 | 0.2 | 0.2 | 0.2 |
| Binder mixing and bar manufacture | | | | |
| Binder solids (%) | 17.5 | 17.5 | — | — |
| Binder component solids content (%) | — | — | 25.0 | — |
| pH of binder mixture | 9.8 | 8.6 | 7.3 | 5.9 |
| Curing temperature (° C.) | 200 | 200 | 175 | — |
| Bar properties | | | | |
| Mechanical strength, unaged (kN) | 0.62 | 0.66 | 0.63 | — |
| Mechanical strength, AC aged (kN) | 0.29 | 0.28 | 0.50 | — |
| Mechanical strength, WB aged (kN) | 0.33 | 0.37 | 0.33 | — |
| LOI, unaged (%) | 2.56 | 2.56 | 2.49 | — |
| LOI, autoclave aged (%) | 2.71 | 2.52 | 2.54 | — |
| LOI, water bath aged (%) | 2.61 | 2.60 | 2.01 | — |
| Binder solubility (%) | −2 | −1 | 15 | — |
| Bar weight (g per bar) | 24.9 | 25.9 | 25.9 | — |
| Water absorption, 24 h (%) | 7 | 7 | 20 | — |
| Simulated spinning chamber | | | | |
| emissions | | | | |
| Relative ammonia emission index | 100 | 7 | 3 | — |
| Relative formaldehyde emission | 100 | 169 | 0 | — |
| index | | | | |

^{[a]} Ingredient percentage.
^{[b]} Of binder solids/binder components solids content (used in the tables for practical reasons, but in the definition of binder solids/binder components solids content the additives are included).

TABLE 1-2
Binder mixtures obtained using comparative binder A1

| Example | A1 | 1 | 2 | 3 | 4 | 5 | B1 | 6 |
|---|---|---|---|---|---|---|---|---|
| Binder composition ^{[a]} | | | | | | | | |
| A1 | 100 | 90 | 75 | 50 | 25 | 10 | — | 75 |
| A2 | — | — | — | — | — | — | — | — |
| Binder composition ^{[b]} | | | | | | | | |
| B1 | — | 10 | 25 | 50 | 75 | 90 | 100 | — |
| B2 | — | — | — | — | — | — | — | 25 |
| Binder mixing and | | | | | | | | |
| bar manufacture | | | | | | | | |
| Binder solids/component | 17.5 | 20.0 | 20.0 | 20.0 | 25.0 | 25.0 | 25.0 | 20.0 |
| solids content (%) | | | | | | | | |
| pH of binder mixture | 9.8 | 9.3 | 9.2 | 9.0 | 8.7 | 8.5 | 7.3 | 9.6 |
| Curing temperature (° C.) | 200 | 200 | 200 | 200 | 175 | 175 | 175 | 200 |
| Bar properties | | | | | | | | |
| Mechanical strength, | 0.62 | 0.62 | 0.60 | 0.52 | 0.57 | 0.57 | 0.63 | 0.65 |
| unaged (kN) | | | | | | | | |
| Mechanical strength, | 0.29 | 0.39 | 0.42 | 0.31 | 0.42 | 0.37 | 0.50 | 0.30 |
| AC aged (kN) | | | | | | | | |
| Mechanical strength, | 0.33 | 0.37 | 0.40 | 0.44 | 0.47 | 0.36 | 0.33 | 0.29 |
| WB aged (kN) | | | | | | | | |
| LOI, unaged (%) | 2.56 | 2.57 | 2.45 | 2.52 | 2.51 | 2.54 | 2.49 | 2.50 |
| LOI, autoclave aged (%) | 2.71 | 2.77 | 2.66 | 2.64 | 2.62 | 2.66 | 2.54 | 2.64 |
| LOI, water bath aged (%) | 2.61 | 2.64 | 2.44 | 2.51 | 2.57 | 2.50 | 2.01 | 2.58 |
| Binder solubility (%) | −2 | −3 | 0 | 0 | −2 | 2 | 15 | −3 |
| Bar weight (g per bar) | 24.9 | 27.0 | 25.7 | 26.9 | 27.4 | 26.4 | 25.9 | 27.1 |
| Water absorption, 24 h (%) | 7 | 6 | 7 | 12 | 10 | 11 | 20 | 9 |
| Simulated spinning | | | | | | | | |
| chamber emissions | | | | | | | | |
| Relative ammonia | 100 | 81 | 65 | 33 | 23 | 10 | 3 | 91 |
| emission index | | | | | | | | |
| Relative formaldehyde | 100 | 66 | 17 | 17 | 10 | 0 | 0 | 41 |
| emission index | | | | | | | | |

^{[a]} Based on binder solids.
^{[b]} Based on binder component solids content.

TABLE 1-3
Binder mixtures obtained using comparative binder A2

| Example | A1 | A2 | 7 | 8 | 9 | 10 | B1 |
|---|---|---|---|---|---|---|---|
| Binder composition ^{[a]} | | | | | | | |
| A1 | 100 | — | — | — | — | — | — |
| A2 | — | 100 | 75 | 50 | 50 | 25 | — |
| Binder composition ^{[b]} | | | | | | | |
| B1 | — | — | 25 | 50 | 50 | 75 | 100 |
| B2 | — | — | — | — | — | — | — |
| Binder mixing and | | | | | | | |
| bar manufacture | | | | | | | |
| Binder solids/component | 17.5 | 17.5 | 20.0 | 20.0 | 20.0 | 25.0 | 25.0 |
| solids content (%) | | | | | | | |
| pH of binder mixture | 9.8 | 8.6 | 8.3 | 8.0 | 8.0 | 7.8 | 7.3 |
| Curing temperature (° C.) | 200 | 200 | 200 | 200 | 175 | 175 | 175 |
| Bar properties | | | | | | | |
| Mechanical strength, | 0.62 | 0.66 | 0.69 | 0.47 | 0.49 | 0.60 | 0.63 |
| unaged (kN) | | | | | | | |
| Mechanical strength, | 0.29 | 0.28 | 0.53 | 0.46 | 0.35 | 0.43 | 0.50 |
| AC aged (kN) | | | | | | | |
| Mechanical strength, | 0.33 | 0.37 | 0.50 | 0.53 | 0.43 | 0.40 | 0.33 |
| WB aged (kN) | | | | | | | |
| LOI, unaged (%) | 2.56 | 2.56 | 2.46 | 2.51 | 2.58 | 2.63 | 2.49 |
| LOI, autoclave aged (%) | 2.71 | 2.52 | 2.67 | 2.59 | 2.74 | 2.73 | 2.54 |
| LOI, water bath aged (%) | 2.61 | 2.60 | 2.51 | 2.53 | 2.58 | 2.57 | 2.01 |
| Binder solubility (%) | −2 | −1 | −2 | −1 | 0 | 2 | 15 |
| Bar weight (g per bar) | 24.9 | 25.9 | 27.2 | 26.8 | 26.9 | 26.8 | 25.9 |
| Water absorption, 24 h (%) | 7 | 7 | 10 | 13 | 13 | 13 | 20 |
| Simulated spinning | | | | | | | |
| chamber emissions | | | | | | | |
| Relative ammonia | 100 | 7 | 9 | 8 | 8 | 8 | 3 |
| emission index | | | | | | | |
| Relative formaldehyde | 100 | 169 | 62 | 24 | 24 | 10 | 0 |
| emission index | | | | | | | |

^{[a]} Based on binder solids.
^{[b]} Based on binder component solids content.

1.-23. (canceled)

24. An aqueous binder composition, wherein the composition comprises a mixture of
(i) a phenol-urea-formaldehyde (PUF) binder, and
(ii) a protein binder comprising at least one protein and at least one cross-linker selected from phenol containing compounds.

25. The composition of claim 24, wherein (i) and (ii) are present in a ratio such that a proportion by weight B, based on a combined weight of A+B, ranges from 5% to 95%, B being a weight of binder solids of (ii) and A being a weight of binder solids of (i).

26. The composition of claim 25, wherein the proportion by weight B, based on the combined weight of A+B, ranges from 10% to 90% by weight.

27. The aqueous binder composition according to claim 25, wherein the proportion by weight B, based on the combined weight of A+B, is ranges from 10 to 45% by weight.

28. The composition of claim 24, wherein (i) is a phenol-urea-formaldehyde resole binder.

29. The composition of claim 24, wherein with respect to the starting materials phenol, formaldehyde and urea for preparing (i) a molar ratio of phenol to formaldehyde is from 1:2.5 to 1:6 and/or an amount of urea is from 20% to 60% by weight, based on a total weight of phenol, formaldehyde and urea.

30. The composition of claim 24, wherein with respect to the starting materials phenol, formaldehyde and urea for preparing (i) a molar ratio of phenol to formaldehyde is from 1:3 to 1:5 and/or an amount of urea is from 30% to 50% by weight, based on a total weight of phenol, formaldehyde and urea.

31. The composition of claim 24, wherein (i) is not modified with ammonia.

32. The composition of claim 24, wherein (i) is modified with ammonia, an amount of ammonia being up to 6% by weight, based on a total weight of the starting materials phenol, formaldehyde and urea for preparing (i).

33. The composition of claim 24, wherein the composition comprises at least two proteins, one protein being at least one protein selected from proteins from animal sources and another protein being at least one protein selected proteins from vegetable sources.

34. The composition of claim 24, wherein the at least one protein comprises or is gelatin, gluten or a combination thereof.

35. The composition of claim 24, wherein the at least one cross-linker comprises or is a tannin.

36. The composition of claim 35, wherein the tannin is selected from one or more of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

37. The composition of claim 24, wherein a content of the at least one cross-linker ranges from 1% to 30% by weight, based on a dry weight of the least one protein.

38. The composition of claim 24, wherein a content of the at least one cross-linker ranges from 2% to 15% by weight, based on a dry weight of the least one protein.

39. The composition of claim 24, wherein a total concentration of (i) and (ii) in the composition ranges from 75% to 100% by weight, based on a total weight of binder solids of (i) and of (ii).

40. The composition of claim 24, wherein a total concentration of (i) and (ii) in the composition ranges from 85% to 97% by weight, based on a total weight of binder solids of (i) and of (ii).

41. The composition of claim 24, wherein (ii) further comprises at least one fatty acid ester of glycerol.

42. A method of producing a mineral fiber product, wherein the method comprises contacting mineral fibers with the binder composition of claim 24 and curing the binder composition.

43. A mineral fiber product, wherein the product comprises mineral fibers bonded by the cured binder composition of claim 24.
